(19) United States
(12) Patent Application Publication
(10) Pub. No.: US 2004/0111544 A1
(43) Pub. Date: Jun. 10, 2004

(54) Method and apparatus for driving two identical devices with a single UBS port

(76) Inventors: Dwayne H. Bennett, Roanoke, VA (US); Mark A. Spangler, Roanoke, VA (US); David W. Boothe, Vinton, VA (US); Charles T. Gore, Pulaski, VA (US); William R. Eanes, Roanoke, VA (US)

Correspondence Address: STURM & FIX LLP, 206 SIXTH AVENUE, SUITE 1213, DES MOINES, IA, 50309-4076, US

(21) Appl. No.: 10/318,671

(22) Filed: Dec. 9, 2002

(51) Int. Cl. G06F 13/12

(52) U.S. Cl. 710/62

(57) ABSTRACT

To optically scan a patient's feet for the purpose of obtaining measurements useful to constructing orthotics, each foot should be scanned while the patient is standing naturally. A logical apparatus for this purpose is one with two scanners, side by side, packaged as a single unit. The scanners would (again, logically) be identical. However, connecting two identical peripheral devices to a computer creates identification difficulties. It is also prudent to minimize the number of communications ports the apparatus uses. To connect two identical optical scanners to a single communications port (such as a Universal Serial Bus port), a switch is employed, for switching the communications port between each scanner; or a USB hub arbitrates the communications between the computer and each scanner. A time delay is used to separate the scans of each scanner in time, so the computer's software can differentiate between the scan of the first foot and the scan of the second foot.

### BACKGROUND OF THE INVENTION

1. Field of the Invention

The present invention relates generally to computer peripherals connected to a computer through a Universal Serial Bus (USB) port. More particularly the present invention relates to a method and apparatus for connecting multiple identical devices to a single USB port.

2. Background Art

For the purpose of constructing custom orthotics, accurate measurements must be made of both feet of the patient. In the past, the measurements were taken using foam box casting—a method of taking the impressions of the feet in foam. A more convenient way to accomplish the task is by optical scanning of the feet.

To effect a scan of both feet, the patient must be standing normally, with weight distributed as usual. The difficulties presented in this case are:

1. A single scanner of sufficient size for both feet is not, presently, available.

2. Many computers do not have sufficient USB ports to connect two scanners, separately.

3. Two identical scanners are difficult for a computer to differentiate between.

The latter may be understood by realizing that a computer must obtain some kind of identification from any peripheral device connected to it, so it knows how to communicate with the device. When two identical peripherals (in this case, scanners) are connected to the computer, it can “confuse” the computer such that it cannot separate information being passed to and from the two devices.

There is, therefore, a need for a method and device for connecting two identical scanners to a computer is a fashion that permits the computer to differentiate between the results received from the scanners, thereby identifying a scan of the right foot separately from that of the left foot. There is an additional need for a method and apparatus to connect two identical peripheral devices through a single USB port, causing the computer to correctly identify each separate device.

### SUMMARY OF THE INVENTION

A purpose of this invention is to provide a method and apparatus for permitting two identical computer peripherals to communicate with a computer via a single communications port such as a Universal Serial Bus (USB) port. An additional purpose of the present invention is for a method and device for optical scanning of patients' feet using two separate but identical scanners, maintaining an identity of each scan as to whether it is the left foot or the right foot.

When peripherals such as printers and scanners are connected to a computer, the computer needs to be able to differentiate between the devices. Usually this is not a problem. When two identical devices are placed in communication with a computer, there is a lack of differentiation and, therefore, “confusion” on the part of the computer. A way to sidestep this difficulty is to time the use of the identical devices such that only one is communicating with the computer at any given instant. Then, provide software to utilize the timing of the switching between devices to keep track of which device is communicating at a given time. The computer and operating system, then, do not need to be “aware” that there are two peripheral devices connected to a USB port. As far as the computer and operating system are concerned, there is only a single device operating at different times. The software, run in conjunction with the peripherals, keeps track of which device is communicating at a given time.

The method just described can be carried out using a dedicated switching system or a common multiplexing device, in this case a USB hub.

A key to this invention is a software system, communicating with each device individually. When a dedicated switching system is used, it connects each device to the computer individually, based on timing. With a pair of scanners, this works as follows. The switch connects scanner A to the computer. Scanner A performs its scan. When the scanner head has traveled its full distance, it contacts switch A. This signals a timer in the switching system to begin a predetermined time delay. After the delay, the switching system connects to scanner B, which goes about its scan. The scanning head for scanner B also contacts a switch, again triggering a timer. After this second delay, the switch, again, connects scanner A to the computer, readying the system for another cycle. Meanwhile, the system's software has been programmed to accept the first scan from scanner A, identifying it as (for example) the right foot. After a known delay, the software “knows” that an additional scan will be emanating from scanner B, identified as the left foot. After an additional time delay, the software is prepared for another scan from scanner A.

When a USB hub is used, the software communicates with each peripheral device individually bases on Operating System (OS) assigned device addresses. With a pair of scanners, this works as follows. The software discovers the peripheral devices' addresses by polling the OS for the addresses assigned to the USB hub's ports and stores this information. User intervention is then necessary to determine which scanner is on which side. One scanner is activated and the user is asked to enter on which side the scanner lies. The left/right information is then correlated to the stored peripheral device addresses. This association is stored in permanent memory, making the configuration procedure a one-time event. When the software is directed to perform imaging scans, the scanner on the right side is activated, and the image retrieved from the scanner and stored. Then the left side scanner is activated, and its image retrieved and stored.

The novel features which are believed to be characteristic of this invention, both as to its organization and method operation together with further objectives and advantages thereto, will be better understood from the following description considered in connection with accompanying drawings in which a presently preferred embodiment of the invention is illustrated by way of example. It is to be expressly understood however, that the drawings are for the purpose of illustration and description only and not intended as a definition of the limits of the invention.

### BRIEF DESCRIPTION OF THE DRAWINGS

FIG. 1 shows a schematic of a computer and scanning system using a USB switch.

FIG. 2 shows a schematic of a computer and scanning system using a USB hub.

FIG. 3 shows a block diagram of the scanning method when using a USB switch.

FIG. 4 shows a block diagram of the scanning method when using a USB hub

FIG. 5 shows a schematic of the switching system's circuitry.

FIG. 6 shows a perspective view of the scanning system.

FIG. 7 shows a view of the scanning system from the vantage point of a patient.

FIG. 8 shows a scanning system in use scanning feet.

FIG. 9 shows measurements being taken from the scan of feet.

FIG. 10 is a perspective view of an orthotic that is constructed using measurements such as those obtained by using the scanning system of the present invention.

### BEST MODE FOR CARRYING OUT THE INVENTION

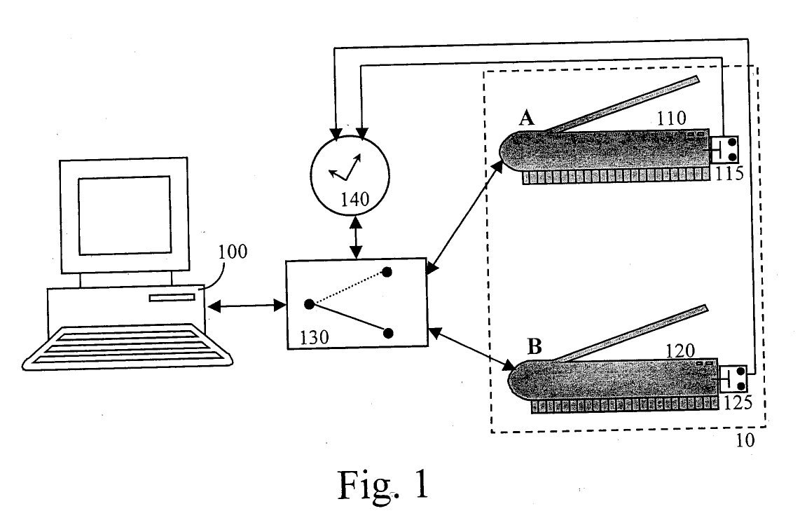

Referring now to the drawings wherein like reference numerals designate identical or corresponding parts throughout the several views, FIG. 1 shows one computer 100 coupled electrically to two scanners 110, 120 within a single unit 10. The two scanners are shown spatially separate, but in the preferred embodiment, the scanners are side by side, allowing a patient to stand, naturally, on both, simultaneously. All communication is two-way, in general, as indicated by the double-arrows. In one embodiment of the invention, each scanner has an associated switch 115, 125 used to signal the end of a scan. A USB switch 130, determines which of the scanners 110, 120 are connected at any given moment to the computer 100. Associated with the USB switch 130 is a timer 140, used to time a delay between when a scanner has finished its scan, according to switches 115 and 125, and the time the switch position is changed.

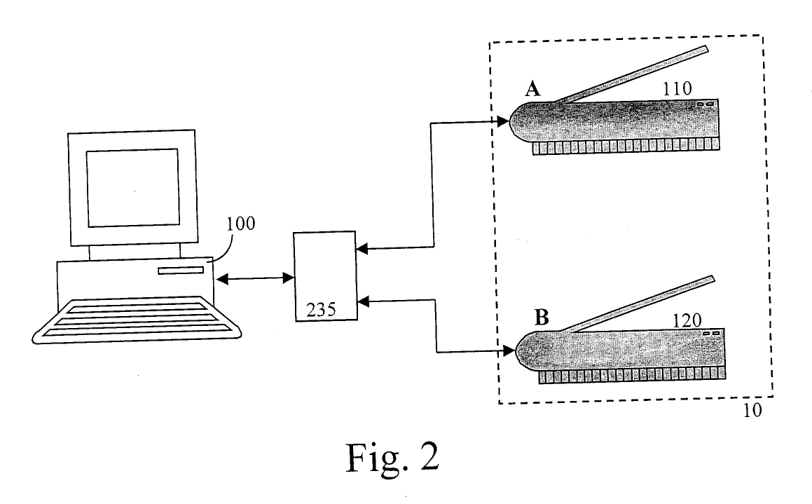

FIG. 2 illustrates a second embodiment of this invention. A USB hub 235 determines which of the scanners 110, 120 are in communication with the computer 100 based on the operating system assigned device addresses.

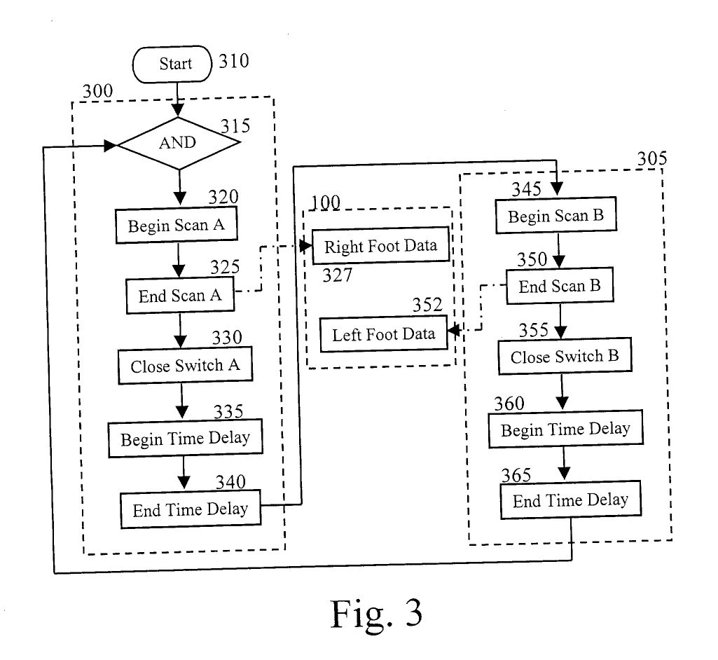

FIG. 3 outlines the scanning cycle in more detail when a USB switch is used. Scanner A's cycle is shown inside the left dashed-box 300, while the cycle associated with Scanner B is shown in the right dashed-box 305. Beginning at the top of the dashed-box 300 for scanner A's cycle 300, the process is initiated by a start signal 310 from the operator (which could be carried out by pressing a “start button” on the scanning apparatus, or through the computer software). The top block within the cycle 300 of scanner A 110, an AND block 315, determines if the cycle has returned to this starting point, and if the start signal 310 has been initiated. If both these conditions are met, scanner A 110 begins scanning 320. At the end of scanner A's 110 scan 325, the scan data 327 for the right foot are sent to the computer 100. At the same time, scanner A's 110 scanning head engages switch A 115 closing its contacts 330. The closing of switch A 115 is sensed by the clock 140, which begins timing a delay 335. At the end of the time delay 340, the USB switch 130 changes position, initiating the scan cycle 305 of scanner B 120. Scanner B 120 begins scanning 345 at the end of the time delay. At the end of the scan 350, the scan data 352 for the left foot are sent to the computer 100. At the same time, switch B 125 is engaged and connection is made 355. This signals the clock 140 to begin timing a delay 360, which, when complete 365, causes switch 130 to return to its initial condition, connecting scanner A 110 to the computer for the next complete cycle.

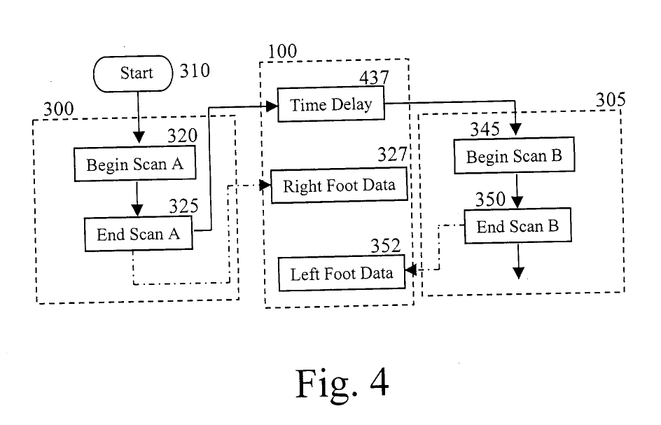

The flow diagram associated with the embodiment of the invention using a USB hub is shown in FIG. 4. Scanner A's cycle is, again, shown inside the left dashed-box 300, while the cycle associated with Scanner B is shown in the right dashed-box 305. Beginning at the top of the dashed-box 300 for scanner A's cycle 300, the process is initiated by a start signal 310 from the operator (which could be carried out by pressing a “start button” on the scanning apparatus, or through the computer software). The top block within the cycle 300 of scanner A 110, shows scanner A 110 beginning its scan 320. At the end of scanner A's 110 scan 325, the scan data 327 for the right foot are sent to the computer 100. At the same time, a time delay 437 is initiated. At the end of the time delay 437, the USB hub 235 switches scanner addresses, initiating the scan cycle 305 of scanner B 120. Scanner B 120 begins scanning 345 at the end of the time delay. At the end of the scan 350, the scan data 352 for the left foot are sent to the computer 100. The completed transmission of the left foot data signals the end of scanner B's scan cycle 250.

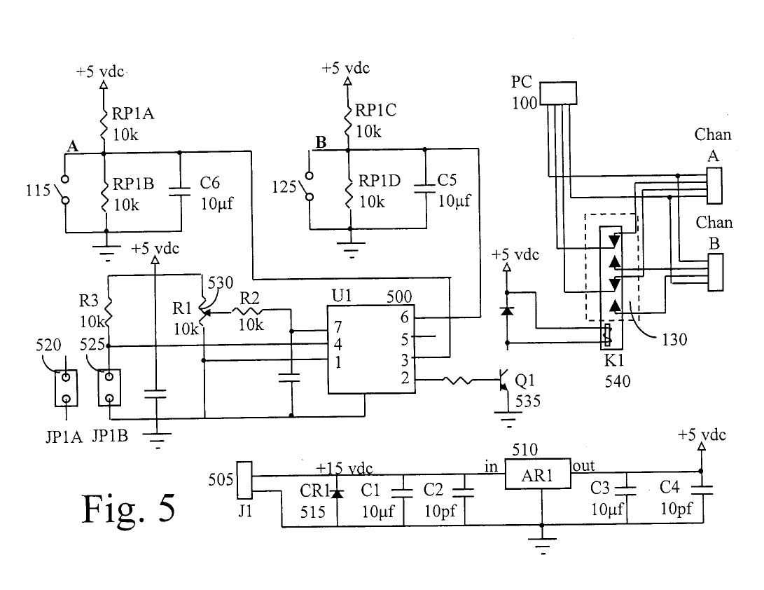

A depiction of the USB switch 130 (for one embodiment of the invention), providing the ability to switch between two USB devices connected to a single USB port on the personal computer 100, is illustrated in FIG. 5. The operation of the switch is based on the programmable microcontroller (U1) 500 and the two switches 115, 125 that are hard mounted to the devices to be switched. In the preferred embodiment, these devices are image scanners. The circuit of FIG. 5 operates as follows.

Positive 15 volts, supplied from a standard power supply furnished with the image scanners 110, 120, is applied to the switch 130 at J1 505. It is converted to +5 vdc by regulator AR1 510 and its support components. The resulting +5 vdc is then used to power the switch 130. A diode 515 provides reverse voltage protection.

Jumpers JP1A 520 and JP1B 525 are used to select which USB device 110, 120 is connected to the PC 100 when power is applied. If a jumper block is placed across JP1A 520, the device connected to Channel A is connected to the computer. If JP1B 525 is jumpered, Channel B is selected. JP1A 520 is normally jumpered, selecting Channel A.

Microcontroller U1 500 contains an adjustable timer 140 that can assume a timing value ranging from 0 to 10 seconds. The timer's value is adjusted continuously through this range by adjusting potentiometer R1 530. Commonly, the voltage at R1's 530 center tap is adjusted to +1 vdc, producing a 1 second timing value.

The currently connected scanner (Channel A) 110 is commanded to perform a scan 310. When the scan head reaches its full travel, it contacts switch A 115, momentarily closing the normally open contact. This causes the voltage on pin 3 of U1 500 to transition from +5 vdc to 0 vdc, triggering U1's 500 internal timer 140. When the timer 140 reaches its terminal count 340, the voltage on pin 2 of U1 500 transitions from 0 vdc to +5 vdc, causing transistor Q1 535 to turn on, which then provides drive current to relay K1 540, connecting Channel B to the computer through switch 130.

The process is repeated for the B Channel: Switch B 125 momentarily closes, causing the voltage on pin 6 of U1 500 to momentarily assume a value of 0 vdc, starting U1's 500 timer. At timer expiration 365, the voltage on pin 2 of U1 500 goes to 0 vdc turning off transistor Q1 535, removing power from relay K1, and reconnecting Channel A to the computer 100 through switch 130.

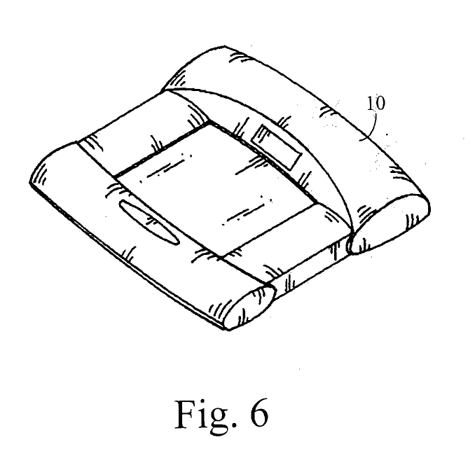

The scanners, packaged in a single unit 10 for scanning feet, are shown in FIG. 6. The scanners 110, 120 are substantially adjacent to one another such that the patient may stand, naturally, on both scanners, simultaneously. An optical image is taken of one foot by each scanner.

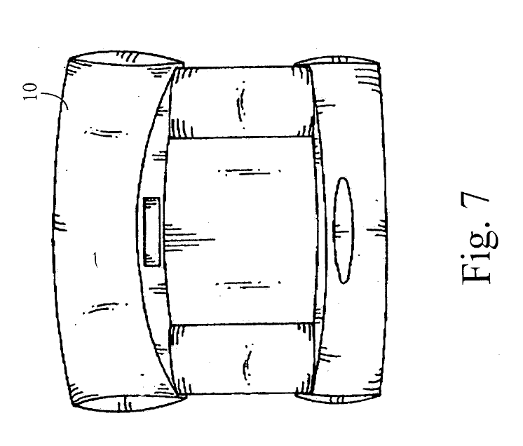

In FIG. 7, the scanning system 10 with two scanners 110, 120 is shown as a patient would see it before stepping on it. The glass plate on which a patient stands, and the structure of the housing, are able to withstand the weight of almost any patient.

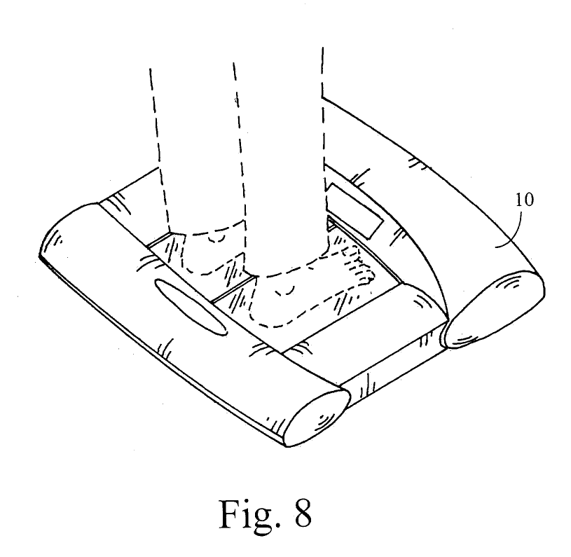

The scanning system 10 with the two scanners 110, 120 (not shown individually) are shown in FIG. 8 in operation, scanning feet. The unit 10 is built such that a patient can stand, normally, on the glass plate over the scanners.

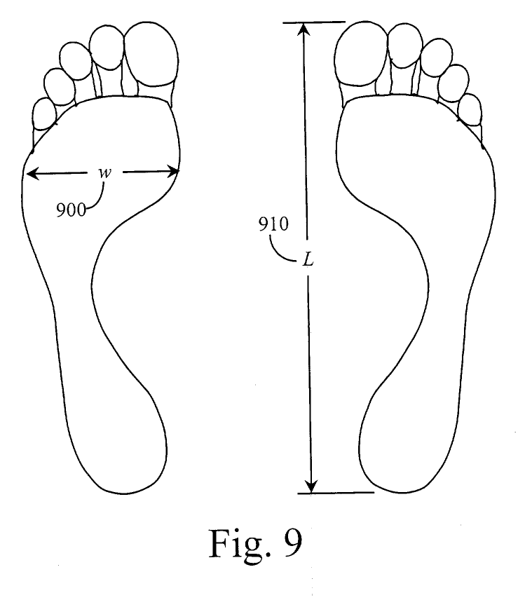

Measurements: width, w 900, and length, L 910, of feet are shown in FIG. 9. The scanning system, with its software, produces an image from which these measurements (as well as others) can be taken. The measurements are used to produce customized orthotics.

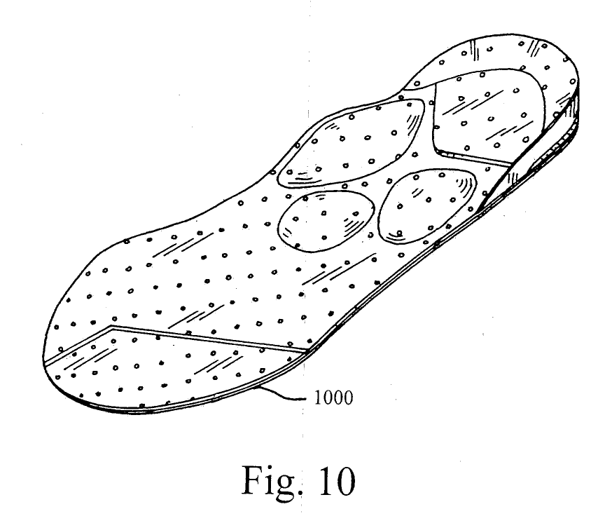

FIG. 10 shows an orthotic 1000 that is constructed using measurements such as those obtained by using the scanning system 10.

The above embodiment is the preferred embodiment, but this invention is not limited thereto. Other electrical components and configuration can be envisioned. It is, therefore, obvious that many modifications and variations of the present invention are possible in light of the above teachings. It is, therefore, to be understood that within the scope of the appended claims, the invention may be practiced otherwise than as specifically described.

We claim:

1. A method of connecting a plurality of computer peripheral devices to a computer through a single communications port whereby said computer peripheral devices deliver data to the computer through the single communications port, the method comprising the steps of:
(a) communicating with the plurality of computer peripheral devices, sequentially; and
(b) differentiating between the data received from the plurality of computer peripheral devices based on a sequence at which they execute their functions.

2. The method of claim 1 wherein the plurality of computer peripheral devices are identical.

3. The method of claim 1 wherein a time delay is executed after each execution of the computer peripheral devices' functions.

4. The method of claim 1 wherein the function of the computer peripheral devices is scanning.

5. The method of claim 1 wherein the computer peripheral devices are optical scanners.

6. The method of claim 1 wherein the single communications port is a Universal Serial Bus (USB) port.

7. The method of claim 1 wherein the computer peripheral devices cause switches to close to signal an end of the execution of their functions.

8. The method of claim 1 wherein the termination of data transfer from the computer peripheral devices signal an end of the execution of their functions.

9. The method of claim 5 wherein two optical scanners are used to scan feet for the purpose of obtaining measurements for constructing orthotics.

10. The method of claim 9 wherein the optical scanners are disposed substantially adjacent to one another so a patient can stand normally with one foot on each optical scanner.

11. An apparatus for connecting a plurality of computer peripheral devices to a computer through a single communications port whereby said computer peripheral devices deliver data to the computer through the single communications port, the apparatus comprising:
(a) means for communicating with the plurality of computer peripheral devices, sequentially; and
(b) means for differentiating between the data received from the plurality of computer peripheral devices based on the sequence at which they execute their functions.

13. The apparatus of claim 11 wherein the plurality of computer peripheral devices are identical.

13. The apparatus of claim 11 wherein a timer provides a time delay after each execution of the computer peripheral devices' functions.

14. The apparatus of claim 11 wherein the function of the computer peripheral devices is scanning.

15. The apparatus of claim 11 wherein the computer peripheral devices are optical scanners.

16. The apparatus of claim 11 wherein the single communications port is a Universal Serial Bus (USB) port.

17. The apparatus of claim 11 wherein a switch is associated with each computer peripheral device which cause said switch to close to signal an end of the execution of their functions.

18. The apparatus of claim 11 wherein the termination of data transfer from the computer peripheral devices signal an end of the execution of their functions.

19. The apparatus of claim 15 wherein two optical scanners are used to scan feet for the purpose of obtaining measurements for constructing orthotics.

20. The apparatus of claim 19 wherein the optical scanners are placed substantially adjacent to one another so a patient can stand normally with one foot on each optical scanner.
